(19) United States
(12) Patent Application Publication
(10) Pub. No.: US 2015/0203694 A1
(43) Pub. Date: Jul. 23, 2015

(54) CONDUCTIVITY THICK FILM PASTES CONTAINING PLATINUM POWDER

(71) Applicants: HOWARD DAVID GLICKSMAN, Durham, NC (US); MARC H LABRANCHE, Chapel Hill, NC (US); PATRICIA O. MARKHAM, Raleigh, NC (US); ADELE AMELIA PLISCOTT, Bristol (GB)

(72) Inventors: HOWARD DAVID GLICKSMAN, Durham, NC (US); MARC H LABRANCHE, Chapel Hill, NC (US); PATRICIA O. MARKHAM, Raleigh, NC (US); ADELE AMELIA PLISCOTT, Bristol (GB)

(73) Assignee: E I DU PONT DE NEMOURS AND COMPANY, Wilmington, DE (US)

(21) Appl. No.: 14/598,279

(22) Filed: Jan. 16, 2015

Related U.S. Application Data
(60) Provisional application No. 61/928,774, filed on Jan. 17, 2014.

(51) Int. Cl. C09D 5/24; C22B 3/00; B05D 5/00; B22F 9/30; B05D 3/02

(52) U.S. Cl. CPC C09D 5/24; B22F 9/30; B05D 3/0254; B05D 5/00; C22B 11/04

(57) ABSTRACT

The present invention is directed to a highly conductive, low sintering temperature platinum powder produced using an aerosol decomposition process with platinum (II) tetraamine diacetate as the precursor

### CROSS REFERENCE TO RELATED APPLICATION

This application claims priority to U.S. Provisional Application No. 61/928,774, filed Jan. 17, 2014.

### FIELD OF THE INVENTION

The field of the present disclosure is platinum powder and thick film pastes, typically used in the automotive, transportation and/or electronics industries for creating metal based structures, such as, sensor electrodes, igniters, controllers, electrical connections and/or the like, particularly in hostile environments and most particularly where high reliability is required.

### TECHNICAL BACKGROUND OF THE DISCLOSURE

A need exists for improved platinum powder and thick film pastes containing such powder to enable denser fired conductive lines more resistant to hostile conditions such as exhaust gasses.

U.S. Pat. No. 6,165,247 to Kodas, et al., discloses a pyrolysis method for the production of platinum powder and platinum rhodium powder.

### SUMMARY OF THE INVENTION

The present invention is directed to a highly conductive, low sintering temperature platinum powder produced using an aerosol decomposition process with platinum (II) tetraamine diacetate as the precursor. The present invention is also directed to thick film pastes comprising this highly conductive platinum powder and an organic vehicle which provides a dense, smooth fired paste with higher conductivity than precipitated platinum powders and stability on re-firing. The present invention is also directed to thick film pastes comprising the addition of glass frit and/or platinum rhodium powder. These new thick film pastes containing platinum powder made from platinum (II) tetraamine diacetate allow circuits to be made that have higher conductivity when fired at high temperatures (such as 1200° C.-1300° C.) and very good conductivity when fired at temperatures less than 1000° C. Using these materials will enable lower costs by decreasing the use of platinum and providing wider processing latitude.

### DETAILED DESCRIPTION OF THE INVENTION

It has been found that the thick film paste of the present invention allows for the production of metallization tracks and contact pads for high temperature joining technology for electrodes of sensor devices, in particular, high temperature gas sensor devices such as exhaust gas sensor devices with improved properties. The improved properties may include improved topography of the finished metallizations (such as surface defects like splining, cracks, splits, bubbles and blisters), higher conductivity at a given firing temperature, and the ability to fire at a lower temperature while maintaining a dense structure giving improved resistivity and adhesion and an extended service life.

The thick film paste of the present invention comprises a particulate platinum metal powder and an organic vehicle and may contain a glass frit powder and may contain a platinum rhodium powder. The platinum metal powder is a low temperature sintering powder made from the pyrolysis of a solution of platinum (II) tetraamine diacetate in water that does not contain nitrate or chloride. The platinum rhodium powder is made the same way as the platinum powder except that rhodium (III) acetate solution is added to the starting solution. For the electrode between 0-4% glass frit and 0-1% oxide is used to promote adhesion and match TCE to the substrate (wt. % of paste). This also gives the paste stability for re-firing 1-10 times at 500-1300° C. with controlled resistivity within 0-10% from initial firing. Any pyrolysis process can be applied to the pyrolysis of a platinum (II) tetraamine diacetate that does not contain nitrate or chloride. In one embodiment the pyrolysis process is as disclosed in U.S. Pat. No. 6,165,247 to Kodas, et al. The Kodas patent discloses a pyrolysis method for the production of platinum metal and is hereby incorporated into this specification for all purposes herein.

In one embodiment, pyrolysis is conducted at temperatures between 800° C. and 1300° C. in air. The preferred temperatures are between 900° C. and 1100° C. in air.

In one embodiment, the method for the production of platinum metal powder comprises the steps of: a) generating an aerosol of droplets from a liquid wherein said liquid comprises a platinum (II) tetraamine diacetate precursor and wherein said droplets have a size distribution such that at least about 80 weight percent of said droplets have a size of from about 1 μm to about 5 μm; b) moving said droplets in a carrier gas; and c) heating said droplets to remove liquid therefrom and form platinum metal powder.

In one embodiment, the method for the production of platinum rhodium metal powder comprises the steps of: a) generating an aerosol of droplets from a liquid wherein said liquid comprises a solution of platinum (II) tetraamine diacetate precursor and a rhodium (III) acetate precursor and wherein said droplets have a size distribution such that at least about 80 weight percent of said droplets have a size of from about 1 μm to about 5 μm; b) moving said droplets in a carrier gas; and c) heating said droplets to remove liquid therefrom and form platinum rhodium metal powder.

The particulate platinum metal powder and the particulate platinum rhodium metal powder may exhibit an average particle size of, for example, 0.7 to 1.5 μm. Its surface area may be in the range of, for example, 0.4 to 1.2 m²/g as measured by the BET method.

The term “average particle size” is used herein. It shall mean the average particle size (mean particle diameter, d50) determined by means of laser light scattering assuming a volume average analysis. Laser light scattering measurements can be carried out making use of a particle size analyser, for example, a Microtrac S3500 machine.

All statements made in the present description and the claims in relation to average particle sizes relate to average particle sizes of the relevant materials as are present in the thick film paste as supplied to the user or customer.

In the present description and the claims the term “total thick film paste composition” is used. It shall mean thick film paste as supplied to the user or customer.

The thick film paste of the present invention comprises an organic vehicle. A wide variety of inert viscous materials can be used as the organic vehicle. The organic vehicle may be one in which the platinum particulate metal powder is dispersible with an adequate degree of stability. The properties, in particular, the rheological properties, of the organic vehicle may be such that they lend good application properties to the thick film paste composition, including: stable dispersion of insoluble solids, appropriate rheology for application, appropriate wettability of the paste solids, a drying rate such that the paste can be screen printed, and firing properties such that a high density, low resistivity film is produced. The organic vehicle used in the thick film paste may be a non-aqueous inert liquid. The organic vehicle may be an organic solvent or preferably an organic solvent mixture; in an embodiment, the organic vehicle may be a solution of organic polymer(s) in organic solvent(s). In an embodiment, the polymer used for this purpose may be ethyl cellulose. Other examples of polymers which may be used alone or in combination include ethylhydroxyethyl cellulose, wood rosin, phenolic resins and poly(meth)acrylates of lower alcohols. Examples of suitable organic solvents comprise ester alcohols and terpenes such as alpha- or beta-terpineol or mixtures thereof with other solvents such as kerosene, dibutylsebacate, diethylene glycol butyl ether, diethylene glycol butyl ether acetate, hexylene glycol, 2,2,4-trimethyl-1,3-pentanediol monoisobutyrate and high boiling alcohols. Various combinations of these and other solvents may be formulated to obtain the viscosity and volatility requirements desired.

The organic vehicle content in the thick film paste may be dependent on the method of applying the thick film paste and the kind of organic vehicle used, and it can vary. It may be in the range of 5 to 20 wt. %, based on total thick film paste composition. The organic vehicle content includes organic solvent(s), possible organic polymer(s) and possible organic additive(s).

The organic solvent content in the thick film paste may be in the range of 2 to 50 wt. %, based on total thick film paste composition. The organic polymer(s) may be present in the organic vehicle in a proportion in the range of 0.1 to 5 wt. %, based on total thick film paste composition.

The glass frit powder may be present in the thick film paste in the range of 0.1-5 wt. % and comprises 5-25% SiO₂, 0-5% ZrO₂, 0-5% Al₂O₃, 20-5-% B₂O₃, 0-10% ZnO, 0-10% CaO, and 20-50% BaO on a weight basis . . . .

The thick film paste of the present invention may comprise one or more organic additives, for example, surfactants, thickeners, rheology modifiers and stabilizers. The organic additive(s) may be part of the organic vehicle. However, it is also possible to add the organic additive(s) separately when preparing the thick film paste. The organic additive(s) may be present in the thick film paste in a total proportion of, for example, 0 to 6 wt. %, based on total thick film paste composition.

The thick film paste of the present invention is a viscous composition, which may be prepared by mechanically mixing the inorganic materials (platinum powder and optional glass frit and optional metal oxide(s) or platinum rhodium powder with optional glass frit and optional metal oxide(s) or combinations of the two powders) with the organic vehicle. In an embodiment, the materials were mixed together using planetary or centrifugal mixing and finely dispersed using a three roll mill.

The thick film paste of the present invention can be used as such or may be diluted, for example, by the addition of additional organic solvent(s); accordingly, the weight percentage of all the other constituents of the thick film paste may be decreased.

The application viscosity of the thick film paste of the present invention may be, for example, 100 to 700 Pascal seconds when measured at a spindle speed of 10 rpm and 25° C. by a utility cup using a Brookfield HBT viscometer and #14 spindle.

The thick film paste of the present invention can be used in the manufacture of metallizations which may serve as electrical contacts for electrodes of sensors, in particular, high temperature gas sensors like exhaust gas sensors. Such sensors may serve to determine gas temperature and/or gas composition with regard to one or more gas components. These thick film pastes can also be used in the manufacture of temperature sensors for automobile exhaust systems.

Therefore the invention relates also to a method for the manufacture of electrically conductive metallizations of sensors. The method comprises the steps:

(1) applying a thick film paste of the present invention to a sensor substrate,

(2) drying the thick film paste so applied, and

(3) firing the dried thick film paste to form an electrically conductive metallization on the sensor substrate.

Step (1) is performed by applying a thick film paste of the present invention to the sensor substrate as an electrically conductive sub-layer, in particular to another printed layer of the same metal content. The sensor substrate itself is typically a conventional heat-resistant ceramic substrate, for example, an aluminum oxide substrate or a zirconium oxide substrate. The metallization is so applied as to make contact with the electrode and or form the electrode. The thick film paste is typically applied in a fired thickness of, for example, 5 to 100 μm. The typical application method is printing, in particular, screen printing.

After application, the thick film paste is typically dried and fired to form the finished electrically conductive metallization.

Drying may be performed, for example, for a period of 15 to 90 minutes with the substrate reaching a peak temperature in the range of, for example, 85 to 160° C. Drying can be carried out using single or multi-zone belt ovens or box ovens.

Firing may be performed for a period of, for example, 30 to 60 minutes reaching a peak temperature of 850-1050° C. for 10-30 minutes using a multi zone belt furnace or alternatively using a box furnace 6 to 24 hours with the substrate reaching a peak temperature in the range of, for example, 850 to 1050° C. Firing may happen in the presence of oxygen, in particular, in the presence of air. During firing the organic substance including non-volatile organic material and the organic portion not evaporated during the possible drying step may be removed, i.e. burned and/or carbonized, in particular, burned. The organic substance removed during firing includes organic solvent(s), possible organic polymer(s) and possible organic additive(s).

The process step sequence (1) to (3) may be repeated several times, for example, 1 to 5 times. This may especially be expedient, when a high fired thickness of the metallization of, for example, 50 to 120 μm is desired.

### Powder Examples

The following examples are provided to aid in understanding of the invention, and are not intended to in any way to limit the scope of the invention.

All of the reference powder examples 1-10 were made in an Inconel 601 metal tube. The details of the process variables and the resulting powder characteristics are found in Table 1. The surface area was measured by the BET method using a Micromeritics Tristar. The particle size data was measured using a Micromeritics Microtrac S3500. The crystallite size was measured by x-ray diffraction using a Rigaku Miniflex.

### Examples 1 and 2

### Comparative Examples

A platinum salt precursor solution was prepared using platinum (II) nitrate solution diluted to 10 wt. % metal concentration. An aerosol was then generated using air as the carrier gas flowing at 45 liters per minute and an ultrasonic generator with 36 ultrasonic transducers operating at 1.6 MHz. This aerosol was then sent through an impactor and then sent into a 3 zone furnace with the zones set at the temperature indicated. After exiting the furnace, the aerosol temperature was quenched with air and the dense, finely divided platinum powder was collected in a bag filter.

### Examples 3-5

Examples 3-5 were prepared like Example 1, except the platinum was prepared using platinum (II) tetraamine diacetate solution diluted to 10 wt. % metal concentration.

### Examples 6-8

### Comparative Examples

Examples 6, 7, and 8 were prepared using the procedure described in Example 1 with the addition of rhodium (II) nitrate solution mixed with the platinum (II) nitrate solution to produce platinum rhodium powder. The resulting powder contained 10% rhodium by weight relative to the platinum.

### Examples 9-10

Examples 9 and 10 were prepared using the procedure described in Example 3 with the addition of rhodium (II) acetate solution mixed with the platinum (II) tetraamine diacetate solution to produce platinum rhodium powder. The resulting powder contained 10% rhodium by weight relative to the platinum.

TABLE 1

| | | | Formation | Surface | Crystallite | | | | |
|---|---|---|---|---|---|---|---|---|---|
| | Material | Precursor | Temperature | Area | Size | d10 | d50 | d90 | d95 |
| Example | Type | Chemistry | ° C. | m²/g | A | microns | microns | microns | microns |
| 1 | Pt | A | 800 | 1.13 | 381 | 0.56 | 0.84 | 1.56 | 1.91 |
| 2 | Pt | A | 1050 | 0.54 | 531 | 0.55 | 0.85 | 1.64 | 2.08 |
| 3 | Pt | B | 800 | 0.76 | 539 | 0.56 | 0.91 | 2.65 | 3.94 |
| 4 | Pt | B | 950 | 0.91 | | 0.57 | 0.92 | 1.97 | 2.46 |
| 5 | Pt | B | 1050 | 0.59 | 597 | 0.52 | 0.86 | 2.06 | 2.68 |
| 6 | PtRh | C | 800 | 3.28 | 139 | 0.49 | 0.81 | 1.88 | 2.47 |
| 7 | PtRh | C | 900 | 0.92 | 271 | 0.54 | 0.90 | 1.97 | 2.49 |
| 8 | PtRh | C | 1000 | 0.52 | 369 | 0.46 | 0.74 | 1.58 | 2.02 |
| 9 | PtRh | D | 900 | 0.76 | 486 | 0.55 | 0.88 | 2.57 | 3.69 |
| 10 | PtRh | D | 1000 | 0.65 | 593 | 0.54 | 0.77 | 1.45 | 1.86 |

A is platinum (II) nitrate solution
B is platinum (II) tetraamine diacetate solution
C is platinum (II) nitrate and rhodium (III) nitrate
D is platinum (II) tetraamine diacetate and rhodium (III) acetate

### Paste Examples

The following examples are provided to aid in understanding of the invention, and are not intended to in any way to limit the scope of the invention.

Examples 11 through 13 are thick film pastes made by mixing reference example materials into an organic medium (13% ethyl cellulose solution in beta-terpineol). Then the mixture was roll-milled until a FOG (fineness of grind) of <15/5 was obtained (less than 15 μm for the fourth longest continuous scratch and less than 5 μm for the point at which 50% of the paste is scratched; FOG was determined using a conventional Hegmen gauge having a 25 μm block). The pastes were then diluted by addition of dibutyl sebacate to achieve an appropriate viscosity for printing (100-700 PaS). Additional dibutyl sebacate was required with the commercially available platinum powder due to dispersion difficulty. The additional dibutyl sebacate was added prior to roll milling to fully wet the platinum powder. Example 11 contained a commercially available aqueous precipitated platinum powder to be used as a comparative example. Example 12 contained an A type of platinum powder made using platinum (II) nitrate solution. Example 13 contained a B type of platinum powder made using platinum (II) tetraamine diacetate solution.

Examples 14-15 are thick film pastes made by mixing reference example materials into an organic medium (ethyl cellulose solution in beta-terpineol). Then the mixture was roll-milled until a FOG (fineness of grind) of <6/3 was obtained (less than 6 μm for the fourth longest continuous scratch and less than 3 μm for the point at which 50% of the paste is scratched; FOG was determined using a conventional Hegmen gauge having a 25 μm block). The paste produced a viscosity (100-700 PaS) appropriate for printing. Example 14 contained a commercially available aqueous precipitated platinum powder to be used as a comparative example. Example 15 contained a B type of platinum powder made using platinum (II) tetraamine diacetate solution.

The example thick film pastes were screen printed on an alumina substrate in a total fired layer thickness of 6-16 microns. Each print was dried 15 minutes with the substrate reaching a peak temperature of 150° C. and then fired in a belt furnace at a peak temperature of 850° C.

The surface of the finished print was then evaluated by optical and electron microscopy to discern smoothness and fired porosity.

Table 2 shows paste compositional data and the results of the surface evaluations. Thick film pastes containing platinum powder type B (made from platinum (II) tetraamine diacetate) had improved surface topography and lower resistivity.

TABLE 2

| | Ethyl | | | | | | |
|---|---|---|---|---|---|---|---|
| | cellulose + | | | | | Resistivity | |
| | organic | Platinum | Platinum | | | mOhm per | |
| | solvents | powder | powder | | | square at | |
| Ex # | (wt. %) | (Wt. %) | type | FOG | Surface | 10 μm | |
| 11* | 16.2 | 83.7 | Aqueous | 6/5 | Porous, | 88 @ 850 | C. |
| | | | precipitated | | rough | | |
| 12 | 15 | 85 | A | 6/2 | Smooth | 45 @ 850 | C. |
| 13 | 15 | 85 | B | 7/2 | Smooth | 30 @ 850 | C. |
| 14* | | | Aqueous | | Porous, | 88.8 @ 850 | C. |
| | | | precipitated | | rough | | |
| 15 | 15.58 | 83.12 | B | 6/2 | Smooth | 17 @ 1340 | C. |

*comparative example

Table 3 shows initial and refire stability with respect to resistivity. The thick film pastes containing platinum powder type B (made using platinum (II) tetraamine diacetate) shows significantly lower resistivity and less change vs a control using commercially available powder.

TABLE 3

| | | Number of refires | | | | |
|---|---|---|---|---|---|---|
| | Platinum | Resistivity | | | | |
| Example | powder | mOhm per square at 10 μm | | | | |
| number | type | 1 | 2 | 3 | 4 | 5 |
| 16* | Aqueous | 88.8 | 82.5 | 81.5 | 79.3 | 78.2 |
| | precipitated | | | | | |
| 17 | B | 17.2 | 16.8 | 16.7 | 16.6 | 16.5 |

*comparative example

Examples 18 through 21 are thick film pastes containing the PtRh powder. The pastes were made by mixing reference example materials into an organic medium mixture (approximately 12% ethyl cellulose solution in beta-terpineol+dibutly sebacate solvent mixture) plus soya lecithin surfactant. Then the mixture was roll-milled until a FOG (fineness of grind) of <15/5 was obtained (less than 15 μm for the fourth longest continuous scratch and less than 5 μm for the point at which 50% of the paste is scratched; FOG was determined using a conventional Hegman gauge having a 25 μm block). The pastes were then diluted as-needed by addition of additional organic medium to achieve an appropriate viscosity for printing (100-600 PaS). The final compositions contained on a weight basis approximately 1.8% surfactant, 1.0-1.1% resin, 3.8-4.3% terpineol and 3.3-4.1% DBS.

The glass frit used in Examples 20 and 21 had the following composition on a weight basis: 15.57% SiO2, 2.77% ZrO2, 35.28% B2O3, 6.32% CaO, 4.59% ZnO, 0.90% CuO, and 34.57% BaO.

The resistivity of the fired conductor compositions was measured using a 200 square line of 0.020″width. Line resistance was measured with an LCR meter in a 4-wire configuration (Agilent Tech), and fired thickness was measured with a surface profilometer (KLA-Tencor, Model AS-500). A sheet resistivity was calculated per square of conductor track, normalized to 10 microns fired thickness. The unit of milliohms/square at 10 microns fired thickness is the same as the unit of bulk resistivity reported as micro ohm-cm. Bulk Pt resistivity is quoted as 10.3 micro ohm-cm at 25° C., and 90Pt-10Rh is quoted as 18.8 micro ohm-cm at 20° C. It's preferable that the fired layers be as close as possible to the bulk values. In practice, a resistivity of less than about 100 milliohm/sq/10 microns is preferred, with less than about 50 milliohm/sq/10 microns more preferable.

Adhesion of the fired conductor to the substrate was measured after applying fritless Pt-Rh overprint on it and firing it. The overprint provides a more uniformly solderable surface than the fritted Pt-Rh conductor. Adhesion was measured using an Instron Model 1122 pull tester in a 90° C. peel configuration at a pull rate of 2 inches per minute. Twenty gauge pre-tinned wires were attached to 80 mil×80 mil pads on the overprint by solder dipping for 10 25 seconds in 96.5Sn/3.0Ag/0.5Cu solder at 245° C., using Alpha 611 flux. Initial adhesion was measured after soldering and equilibrating overnight at room temperature. A minimum of 15 pads each were pulled for the adhesion test. An average peel force of at least 18 newtons, and preferably over 25 newtons, is considered to be essential for most applications where a wire or lead is attached to the fired conductor.

Table 4 shows that the thick film pastes containing the PtRh powder type D (made using platinum (II) tetraamine acetate and Rh (III) acetate) gave lower resistivity and good adhesion (examples that contain glass frit).

TABLE 4

| | Ethyl | | | | | |
|---|---|---|---|---|---|---|
| | cellulose + | | | | Resistivity | |
| | organic | Glass | Pt/Rh | Pt/Rh | mOhm per | |
| | solvents | frit | powder | powder | square at | Adhesion |
| Ex # | (wt. %) | wt. % | (Wt. %) | type | 10 μm | (N) |
| 18 | 10.75 | NA | 89.25 | C | 102 | NA |
| 19 | 11.09 | 1.7 | 87.21 | C | 113 | 21 |
| 20 | 10.00 | NA | 90.00 | D | 42 | NA |
| 21 | 10.50 | 2.20 | 87.30 | D | 42 | 31 |

C = Pt (II) nitrate and Rh (III) nitrate
D = Pt (II) tetraamine acetate and Rh (III) acetate

We claim:

1. A method for the manufacture of a finely divided, low temperature sintering, highly conductive platinum powder comprising the sequential steps:
A. forming an aerosol consisting essentially of finely divided droplets of a precursor solution of platinum(II) tetraamine diacetate in a thermally volatilizable solvent dispersed in a carrier gas forming a precursor solution of platinum(II) tetraamine diacetate platinum containing compound, wherein the droplets have a droplet concentration which is below the concentration where collisions and subsequent coalescence of the droplets results in a 10% reduction in the droplet concentration;
B. heating the aerosol to an operating temperature above a decomposition temperature of the precursor solution of platinum(II) tetraamine diacetate containing compound, wherein (1) the solvent is volatilized, (2) the platinum containing compound is decomposed to form a finely divided platinum powder; and
C. separating the finely divided platinum powder from the carrier gas, reaction by-products, and solvent volatilization products.

2. A method of claim 1 where the temperature in Step B is between 800° C. and 1300° C.

3. A method of claim 1 where the temperature in Step B is between 900° C. and 1100° C.

4. A method of claim 1 where the carrier gas is air.

5. The method of claim 1, wherein the platinum particulate powder using a platinum (II) tetraamine diacetate precursor solution which has 8-12% Pt by weight in water.

6. A method of claim 1 wherein rhodium(II) acetate solution is added to the platinum(II) tetraamine diacetate precursor solution in step A.; a platinum rhodium powder is formed in Step B; and Step C separating the finely divided platinum rhodium alloy powder carrier gas, reaction by-products, and solvent volatilization products.

7. A method of claim 6 where the temperature in Step B is between 800° C. and 1300° C.

8. A method of claim 6 where the temperature in Step B is between 900° C. and 1100° C.

9. A thick film paste comprising 50-95% of a finely divided, low temperature sintering, highly conductive platinum powder using platinum(II) tetraamine diacetate as the precursor solution, 2-50% of a solvent such as alpha or beta terpineol, texanol, diethylene glycol butyl ether, hexylene glycol, dibutyl sebacate, and other high boiling alcohols, 0-5% ethyl cellulose, wood rosin, ethyl hydroxycellulose, phenolic resin, phenoxy resin or poly (meth)acrylates of lower alcohols, 0-7% glass fit, 0-3% inorganic oxide, and 0-3% surfactant, weight basis paste.

10. The thick film paste in claim 9 wherein the glass frit content is 0.1-5% and comprises 5-25% SiO2, 0-5% ZrO2, 0-5% Al2O3, 20-50% B2O3, 0-10% ZnO, 0-10% CaO, and 20-50% BaO on a weight basis.

11. The thick film paste in claims 9 or 10 comprising 80-93% platinum powder, 0.3-2% ethyl cellulose, 2-19% beta terpineol and 0-10% dibutyl sebacate.

12. A thick film paste comprising 50-95% of a finely divided, low temperature sintering, highly conductive platinum rhodium powder using platinum (II) tetraamine diacetate as a precursor solution with the addition of a rhodium(II) acetate solution, a 2-50% solvent such as alpha or beta terpineol, texanol, diethylene glycol butyl ether, hexylene glycol, dibutyl sebacate, and other high boiling alcohols, 0-5% ethyl cellulose, wood rosin, ethyl hydroxycellulose, phenolic resin, phenoxy resin or poly (meth)acrylates of lower alcohols, 0-7% glass frit, 0-3% inorganic oxide, and 0-3% surfactant, weight basis paste.

13. The thick film paste in claim 12 wherein the glass frit content is 0.1-5% and comprises 5-25% SiO2, 0-5% ZrO2, 0-5% Al2O3, 20-50% B2O3, 0-10% ZnO, 0-10% CaO, and 20-50% BaO on a weight basis.

14. The thick film paste in claims 12 or 13 comprising 80-93% platinum rhodium powder, 0.3-2% ethyl cellulose, 2-19% beta terpineol and 0-10% dibutyl sebacate.

15. A method for the manufacture of electrically conductive metallizations of sensors comprising the steps of (1) applying a thick film paste of claims, 10, 12 or 13 to a substrate, (2) drying the thick film paste so applied, and (3) firing the dried thick film paste to form an electrically conductive metallization on the sensor substrate

16. The method of claim 15 wherein fritless platinum paste of claim 9 is applied over previously applied platinum paste.

17. The method of claim 15 wherein fritless platinum paste of claim 11 is applied over previously applied platinum paste.

18. The method of claim 15 wherein fritless platinum-rhodium paste of claim 12 is applied over previously applied platinum-rhodium paste.

19. The method of claim 15 wherein fritless platinum-rhodium paste of claim 14 is applied over previously applied platinum-rhodium paste

20. The method of claim 16, wherein firing is performed at or below 1050° C.

21. The method of claim 17, wherein firing is performed at or below 1050° C.

22. The method of claim 18 wherein firing is performed at or below 950° C.

23. A fired circuit made from the methods of claims 15, 16, 17, 18 or 19.
